(19) United States
(12) Patent Application Publication
(10) Pub. No.: US 2014/0209777 A1
(43) Pub. Date: Jul. 31, 2014

(54) TRIGGER ACTUATED CLAMP FOR SMART PHONE CAMERA

(71) Applicants: Jeff Klemin, (US); INFOMERICIALS, INC., Springville, UT (US)

(72) Inventors: Jeff Klemin, Cedar Hills, UT (US); Douglas J. Fowkes, Provo, UT (US); John Omdahl, Lindon, UT (US); Michael Horito, Provo, UT (US); Steve Boynton, Spanish Fork, UT (US); Michael Anderson, Springville, UT (US); Tyler Allan, Springville, UT (US)

(73) Assignees: Informericials, Inc., Springville, UT (US); Jeff Klemin, Lehi, UT (US)

(21) Appl. No.: 13/750,952

(22) Filed: Jan. 25, 2013

(51) Int. Cl. F16M 13/04

(52) U.S. Cl. CPC F16M 13/04
USPC 248/544; 29/525.08

(57) ABSTRACT

A trigger actuated clamp holds a smart phone camera on a monopod and includes a movable jaw slidable with respect to a stationary jaw, and a pair of opposing fingers oriented parallel and spaced-apart from one another and carried by the jaws. A base is attached to the stationary jaw and forms at least a portion of a vertically oriented grip. A trigger is attached to the movable jaw and extends therefrom to oppose the grip and spaced-apart from the grip. The trigger is pullable towards the grip to displace the pair of jaws, and thus the pair of opposing fingers, away from one another. The clamp also has bias means for biasing the pair of jaws, and thus the pair of fingers, towards one another, and for biasing the trigger away from the grip.

### BACKGROUND

1. Field of the Invention

The present invention relates generally to a clamp or holder for a camera, cell phone or the like on a monopod, tripod, or the like.

2. Related Art

Cellular telephones are increasingly used to capture digital images and videos. Such devices tend to be small, hand held devices whose primary function is as a telephone, not a digital camera or video recorders. Thus, it can be difficult to hold the device steady while capturing images or video. Tripods are available for digital cameras or video recorders, but have a standard camera mount that cell phones typically lack. In addition, such tripods tend to be big a bulky, as opposed to the small nature of cell phones.

### SUMMARY OF THE INVENTION

It has been recognized that it would be advantageous to develop a method or apparatus to hold or steady a cellular telephone, digital camera, or the like, while taking pictures and/or video. In addition, it has been recognized that it would be advantageous to develop a method or apparatus to hold a cellular telephone or digital camera that is collapsible for portability and easy storage, such as in a pocket.

The invention provides a trigger actuated clamp to hold a smart phone camera. The clamp has a pair of telescoping jaws including a stationary jaw and a movable jaw slidable with respect to the stationary jaw. A pair of opposing fingers is oriented parallel and spaced-apart from one another and is carried by the pair of jaws. A base is attached to the stationary jaw and forms at least a portion of a vertically oriented grip. A trigger is attached to the movable jaw and extends therefrom to oppose the grip and spaced-apart from the grip. The trigger is pullable towards the grip to displace the pair of jaws, and thus the pair of opposing fingers, away from one another. The clamp also includes bias means for biasing the pair of jaws, and thus the pair of fingers, towards one another, and for biasing the trigger away from the grip.

In accordance with a more detailed aspect of the present invention, the pair of fingers can have at least two positions, including: 1) a closed position in which the pair of fingers are spaced-apart from one another in a narrower distance; and 2) an open position in which the pair of fingers are spaced-apart from one another in a wider distance. The pair of fingers can remain parallel as the pair of jaws displace. The stationary jaw can have a proximal opening and a distal slot, while the movable jaw can have an arm extending through the proximal opening and into the stationary jaw. The trigger can be attached to the arm of the movable jaw and can extend therefrom out of the slot. The stationary jaw can have a proximal opening having a U-shaped cross-section with a tongue extending into the opening. The arm of the movable jaw can have a U-shaped cross-section extending through the proximal opening in the stationary jaw. The trigger can be disposed on a proximal end of the arm. The bias means can include a spring disposed between the tongue of the stationary jaw and the trigger. An intervening platform can be disposed between the pair of fingers and oriented perpendicular thereto. The pair of fingers and the intervening platform can have a concave channel formed therein configured to cup at least a portion of a perimeter edge of the smart phone camera. The platform can be bifurcated with one portion carried by the stationary jaw and the other portion carried by the movable jaw. The pair of fingers and the pair of jaws form a block C-shape to engage three contiguous lateral sides of the smart phone camera without obstructing a longitudinal front or back of the smart phone camera. The pair of jaws can include a pair of L-shaped members with vertical fingers and telescoping horizontal arms, with a proximal end of the arm of the stationary jaw attached to the base, and a proximal end of the arm of the movable jaw attached to the trigger. The base can include a coupling coupled to a monopod; and a joint with a horizontally oriented, longitudinal pivot axis attached to the coupling. The pair of jaws can be pivotal about the longitudinal pivot axis between: 1) a landscape orientation in which the pair of fingers are vertically oriented; and 2) a portrait orientation in which the pair of fingers are horizontally oriented. The base can include a pair of joints coupled between the coupling and the pair of jaws, and each having a pivot axis oriented perpendicular to one another. The clamp can be used with a monopod coupled to the pair of jaws, and a smart phone camera releasably held by the pair of jaws. The pair of fingers and an intervening platform can have a concave channel formed therein cupping a perimeter edge of the smart phone camera around at least a majority of the perimeter edge while exposing substantially all of a rear of the smart phone camera.

In addition, the invention provides a trigger actuated clamp in combination with a monopod and a smart phone camera. The clamp has includes a coupling coupled to the monopod, and a joint with a longitudinal pivot axis attached to the coupling. The monopod, or the coupling and the joint, or both form a substantially vertically oriented grip. A pair of telescoping jaws are coupled to the joint, and include a stationary jaw and a movable jaw slidable with respect to the stationary jaw. The stationary jaw has a proximal opening and a distal slot. The movable jaw has an arm extending through the proximal opening and into the stationary jaw. The pair of jaws has a pair of opposing fingers oriented parallel and spaced-apart from one another, and movable towards and away from one another. An intervening platform is disposed between the pair of fingers and oriented perpendicular thereto. A spring biases the pair of fingers towards one another. A trigger is attached to the arm of the movable jaw and extends therefrom out of the slot of the stationary jaw to oppose the grip and spaced-apart therefrom. The trigger is biased away from the grip by the spring. The trigger is pullable towards the grip to displace the pair of jaws, and thus the pair of opposing fingers, away from one another. The pair of fingers and the intervening platform have a concave channel formed therein. The pair of fingers and the intervening platform cup a perimeter edge of the smart phone camera around at least a majority of the perimeter edge while exposing substantially all of a rear of the smart phone camera. The pair of fingers has at least two positions, including: 1) a closed position in which the pair of fingers are spaced-apart from one another in a narrower distance; and 2) an open position in which the pair of fingers are spaced-apart from one another in a wider distance. The pair of fingers and the pair of jaws form a block C-shape to engage three contiguous lateral sides of the smart phone camera without obstructing longitudinal front or back of the smart phone camera. The pair of jaws includes a pair of L-shaped members with vertical fingers forming the pair of fingers, and telescoping horizontal arms, with a proximal end of the arm of the stationary jaw attached to the joint, and a proximal end of the arm of the movable jaw attached to the trigger.

Furthermore, the invention provides a method for holding a smart phone camera, including gripping a base of a clamp, or a monopod attached thereto, or both. The clamp includes the base and a slider slidably coupled thereto and each having a finger extending therefrom in a spaced-apart relationship. The base and slider, and thus the fingers, are biased together. A trigger attached to the slider is pulled to displace the slider and the finger attached thereto away from the base and the finger attached thereto to separate the fingers and open the clamp. The smart phone camera is inserted between the fingers. The trigger is released to allow the slider and the finger attached thereto to displace towards the base and the finger attached thereto to hold the smart phone camera between the fingers and to close the clamp.

In accordance with a more detailed aspect of the invention, the method can include pushing a button on the base to unlock an upper portion of the base with the smart phone camera pivotally coupled to a lower portion of the base with the monopod; and pivoting the upper portion of the base with the smart phone camera with respect to the lower portion of the base with the monopod. The method can include grasping the smart phone camera; pulling the trigger to displace the slider and the finger attached thereto away from the base and the finger attached thereto to separate the fingers and open the clamp; and removing the smart phone camera from between the fingers. The method can include pushing a button on the base to unlock an upper portion of the base pivotally coupled to a lower portion of the base with the monopod; and pivoting the upper portion of the base from a position away from the monopod to a storage position towards the monopod. The method can include pushing a button on the base to unlock an upper portion of the base pivotally coupled to a lower portion of the base with the monopod; and pivoting the upper portion of the base from a storage position towards the monopod to a use position away from the monopod prior to inserting the smart phone camera

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a front perspective view of a trigger actuated clamp in accordance with an embodiment of the present invention, shown empty and in an open position, or with a slider displaced away from a base, and ready to receive a smart phone camera, cellular phone with a camera, or the like, and in a first or landscape orientation;

FIG. 1b is a front perspective view of the trigger actuated clamp of FIG. 1a, shown empty and in a closed position, or with the slider displace towards the base, and in the landscape orientation;

FIG. 2a is a front view of the trigger actuated clamp of FIG. 1a, shown empty and in the open position, and in the landscape orientation;

FIG. 2b is a front view of the trigger actuated clamp of FIG. 1a, shown empty and in a closed position, and in the landscape orientation;

FIG. 3 is a front view of the trigger actuated clamp of FIG. 1a, shown empty, in a closed position, and in a second or portrait or folded orientation;

FIG. 4a is a top view of the trigger actuated clamp of FIG. 1a, shown empty and in the open position, and in the landscape orientation;

FIG. 4b is a top view of the trigger actuated clamp of FIG. 1a, shown empty and in a closed position, and in the landscape orientation;

FIG. 5a is a bottom view of the trigger actuated clamp of FIG. 1a, shown empty and in the open position, and in the landscape orientation;

FIG. 5b is a bottom view of the trigger actuated clamp of FIG. 1a, shown empty and in a closed position, and in the landscape orientation;

FIG. 6 is a rear view of the trigger actuated clamp of FIG. 1a, shown empty and in the open position, and in the landscape orientation;

FIG. 7 is a left side view of the trigger actuated clamp of FIG. 1a, shown empty;

FIG. 8 is a right side view of the trigger actuated clamp of FIG. 1a, shown empty;

FIG. 9a is a front view of the trigger actuated clamp of FIG. 1a, shown in the open position, and in the landscape orientation, and ready to receive the smart phone camera, cellular phone with a camera, or the like;

FIG. 9b is a front view of the trigger actuated clamp of FIG. 1a, shown in a closed position, and in the landscape orientation, with the smart phone camera, cellular phone with a camera, or the like therein;

FIG. 9c is a front view of the trigger actuated clamp of FIG. 1a, shown in the closed position, and in the portrait orientation, with the smart phone camera, cellular phone with a camera, or the like therein;

FIG. 9d is a right side view of the trigger actuated clamp of FIG. 1a, shown in the landscape orientation, with the smart phone camera, cellular phone with a camera, or the like therein;

FIG. 9e a right side view of the trigger actuated clamp of FIG. 1a, shown in the landscape orientation, with the smart phone camera, cellular phone with a camera, or the like therein, and pivoted about a horizontal axis;

FIG. 10 is a cross-sectional front view of the trigger actuated clamp of FIG. 1a, shown empty and in the open position, taken about line 10 in FIG. 4a;

FIG. 11 is a side view of the trigger actuated clamp of FIG. 1a, shown empty and in the closed position, and in the portrait orientation; and

FIGS. 12-15 are perspective views of the trigger actuated clamp of FIG. 1a.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The terms “smart phone camera” and “digital camera” and “cellular phone” are used interchangeably herein to refer to any type of image capture device, including a digital camera, a film camera, a digital video camera, a cellular phone or cell phone or smart phone with a camera and/or a video camera (iPhone®, Samsung Galaxy®, etc.), tablet computer or portable media player (iPod®, iPad®, etc.). and the like, and similar portable handheld electronic devices that can have enlarged display screens, including a global position system (GPS), and the like.

The term “landscape” and “portrait” are used herein to refer to orientations of the clamp and/or the smart phone camera, digital camera or cellular phone, and can correspond to a wider horizontal and taller vertical orientation, respectively, but not necessarily. The two orientations can be orthogonal or perpendicular to one another, such as horizontal and vertical.

The term “monopod” is used herein to refer to at least one leg that supports the clamp, and thus the smart phone camera. The monopod can include a single leg, or two legs (bipod), three legs (tripod), or more legs. The leg(s) can be telescoping or have telescoping rods or tubes to vary the length between shorter and longer. A monopod with a single leg can be more compact. A bipod or a tripod with two or three legs, respectively, can be used with a single leg, or with all their legs.

The terms “stationary” and “fixed” are used interchangeably herein to refer to a jaw, finger or clamp member that is stationary or fixed relative to an opposing jaw, finger or clamp member that slides or translates with respect to the stationary or fixed jaw, although the stationary or fixed jaw may itself translate or pivot or be movable. Thus, the stationary or fixed jaw, finger or clamp member is itself capable of movement or being moved.

### Description

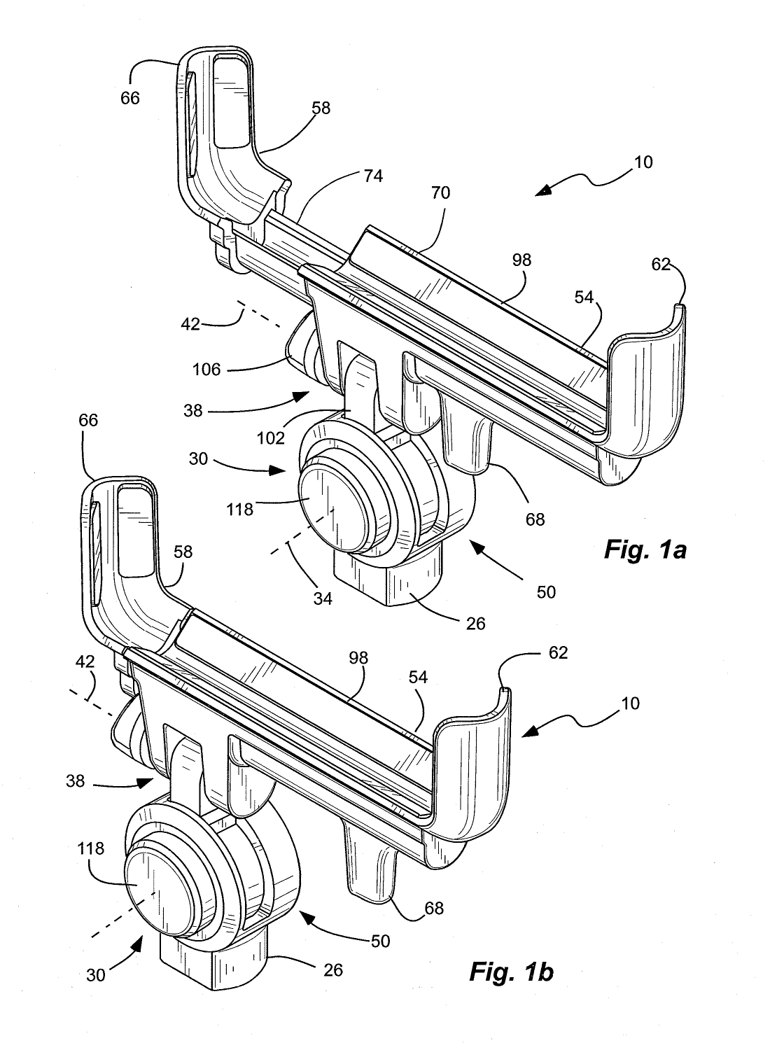

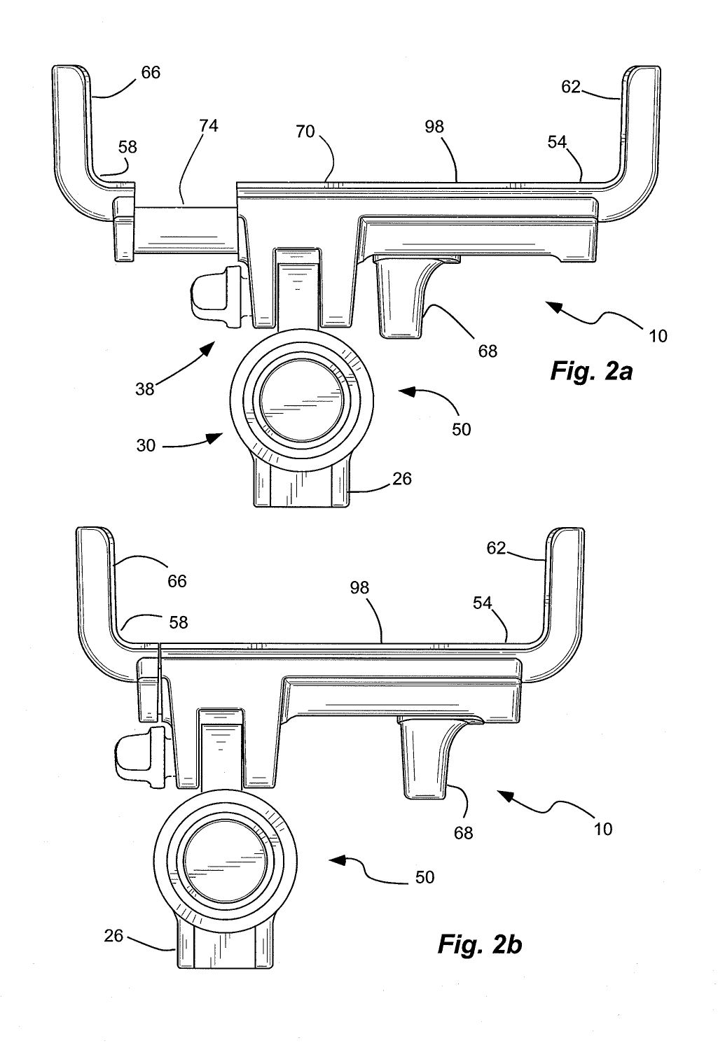

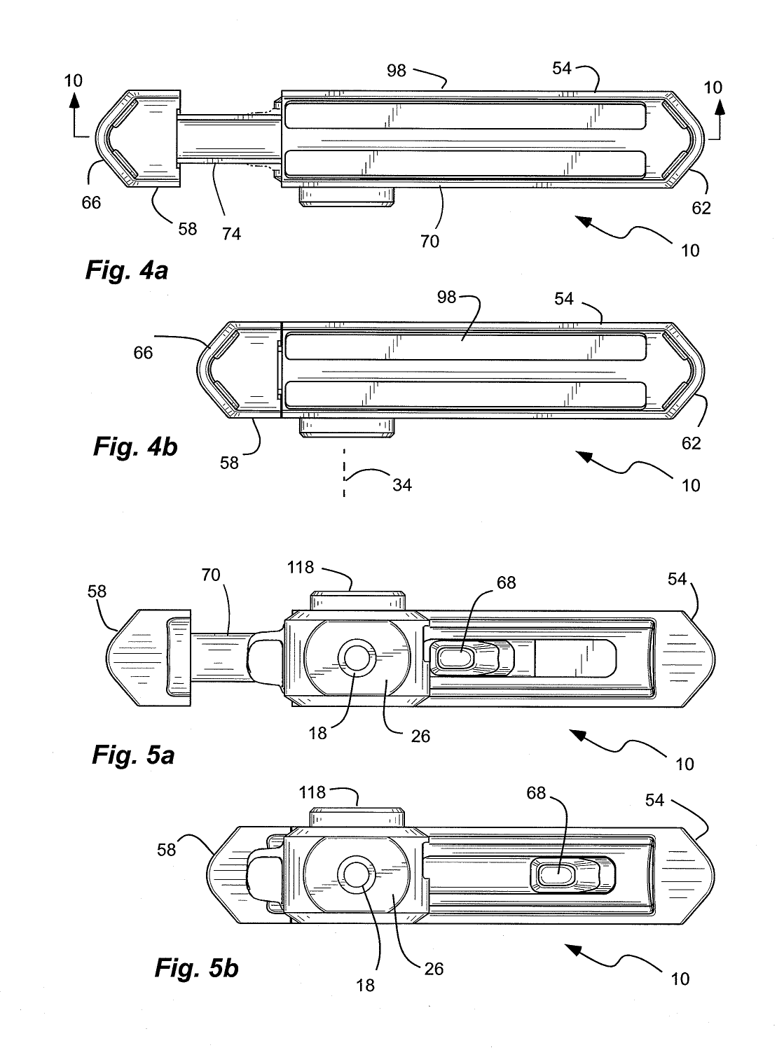

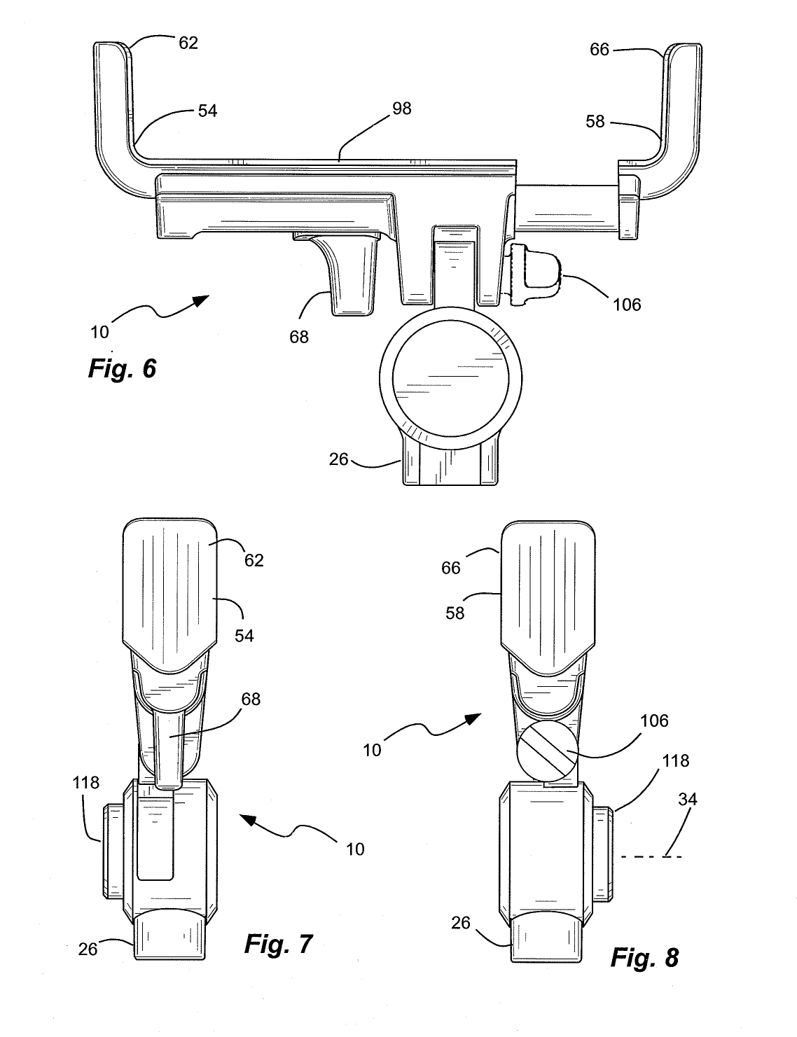

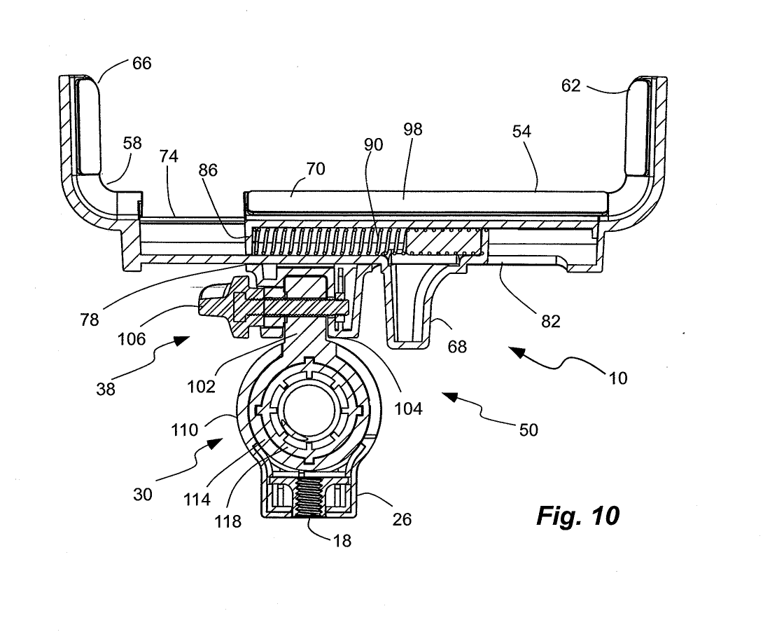

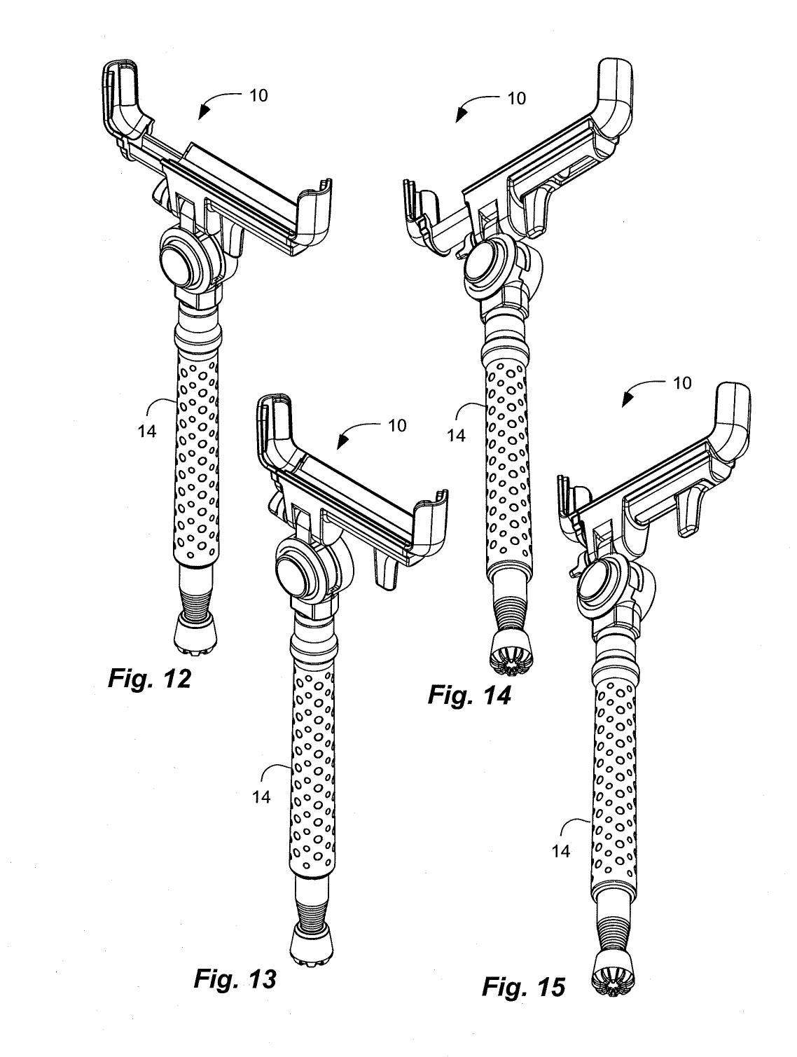

As illustrated in FIGS. 1-15, a trigger actuated clamp, indicated generally at 10, in an example implementation in accordance with the invention is shown. The clamp 10 can be removably coupled to a monopod 14 or the like using a standard camera coupling, such as a rotatable bolt protruding upward from the monopod to engage a threaded bore 18 (FIGS. 5a and b) of the clamp. The clamp can be provided separately to add to a monopod, or provided with or mounted to the monopod. The monopod can have a telescoping leg that can collapse to a short length and extend to a long length or tall height. The clamp 10 can quickly open and close to quickly secure a smart phone camera 22 in the clamp, and thus to the monopod. The clamp can be configured to engage opposite ends or sides of the smart phone camera without obscuring the back or display thereof, or the front or camera thereof, or both. The clamp can pinch opposite sides or the smart phone camera, and/or engage three contiguous sides of the smart phone camera to provide support in different orientations to leave the front and back surfaces of the smart phone camera exposed. In addition, the clamp can cup the perimeter edges of the smart phone camera to provide fore and aft support to the smart phone camera without obscuring the front and back surfaces. Thus, the clamp can be universal to hold a variety of different types and/or sizes of smart phone cameras.

The clamp 10 can have a coupling 26 that couples to the monopod 14. The coupling 26 can include the threaded bore 18. One or more joints can be attached to the coupling. The join(s) can provide an orientation portion of the clamp, or to a clamp portion of the claims. The joint(s) can include a lateral pivot joint 30 with a longitudinal pivot axis 34 oriented horizontally and extending fore and aft with respect to a direction of picture or video capture. The lateral pivot joint can allow the clamp portion pivot 90 degrees between a landscape orientation and a portrait orientation. In addition, the joint(s) can include a longitudinal pivot joint 38 with a lateral pivot axis 42 oriented horizontally and extending laterally, or side-to-side, with respect to the direction of picture or video capture. The longitudinal pivot joint can allow the clamp portion to pivot up and down with respect to the direction of video capture. The lateral pivot joint 30 can be attached to the coupling 26, and the longitudinal pivot joint 38 can be attached to the lateral pivot joint and the clamp portion. Thus, the joint(s) are coupled between the clamp portion and the coupling, and coupled the clamp portion to the coupling. The monopod 14, or the coupling 26 and the joint(s) 30 and/or 38, or both form a substantially vertically oriented grip 46. Thus, a user can grasp the clamp and/or monopod. In addition, the coupling 26 and the joint(s) 30 and/or 38 define a base 50 of the clamp. The base 50 can form at least a portion of the vertically oriented grip 46.

A pair of telescoping jaws can be coupled to and carried by the base 50 or the coupling 26, and coupled to the monopod by the base or the coupling. The pair of jaws can include a stationary jaw 54 and a movable jaw 58 slidable with respect to the stationary jaw. The stationary jaw 54 can be coupled to the base or the coupling, while the movable jaw 58 is slidably coupled to the stationary jaw. The jaws can include a pair of opposing fingers 62 and 66 oriented parallel and spaced-apart from one another and carried by the pair of jaws. The movable jaw 58 can define or form a slider. The stationary jaw 54, or portion thereof, can form a portion of the base 50 of the clamp. The jaws, or fingers and arms, can form a cradle to receive the smart phone camera.

A trigger 68 is attached to the movable jaw 58 and extends therefrom to oppose the grip 50, and spaced-apart from the grip. The trigger 68 is pullable towards the grip 50 to displace the pair of jaws 54 and 58, and thus the pair of opposing fingers 62 and 66, away from one another. The fingers 62 and 66 can be disposed at opposite distal ends of the jaws 54 and 58, respectively. The pair of jaws 54 and 58 can include a pair of L-shaped members with vertical fingers 62 and 66 and telescoping horizontal arms 70 and 74 (in the landscape orientation). A portion of the arm 74 can extend into a portion of the other arm 70. A proximal end of the arm 70 of the stationary jaw 54 can be attached to the base 50 or joint(s) 38 and/or 30, and thus the coupling 26 and monopod. A proximal end of the arm 74 of the movable jaw 58 can be coupled to the arm of the stationary jaw, and attached to the trigger 68.

The stationary jaw 54 can have a proximal opening 78 and a distal slot 82. The movable jaw 58 can have the arm 74 extending through the proximal opening 78 and into the stationary jaw 54, or arm 70 thereof. Thus, the arms are telescoping. The trigger 68 is attached to the proximal end of the arm 74 of the movable jaw 58, and extends therefrom out of the slot 82 to a position opposing the grip 50, as described above. The proximal opening 78 in the stationary jaw can have a U-shaped cross-section with a tongue 86 extending into the opening. The arm 74 of the movable jaw 58 can have a U-shaped cross-section extending through the U-shape proximal opening 78 in the stationary jaw 54. The trigger 68 is disposed on the proximal end of the arm 74, and defines a stop. The arm 74 of the movable jaw 58, or portion thereof, along with the trigger 68 can cover the slot 82 in the arm 70 of the stationary jaw 54 in the closed position. A compression spring 90 can be disposed between the tongue 86 of the stationary jaw 54 and the trigger 68. Thus, the spring 90 biases the fingers 62 and 66 towards one another, and the trigger 68 and the grip 50 away from one another. The spring is one example of a bias means for biasing the pair of jaws, and thus the pair of fingers, towards one another, and for biasing the trigger away from the grip. The spring can be contained and/or covered by the arms 70 and 74 of the jaws.

The jaws, and thus the fingers, can have at least two positions or configuration, including: a closed position or configuration (FIGS. 1b, 2b, 4b, 9b), and an open position or configuration (FIGS. 1a, 2a, 4a, 9a). In the closed position, the pair of fingers 62 and 66 are spaced-apart from one another in a narrower distance, to hold or pinch the smart phone camera therebetween. In the closed position the jaws move towards one another. In the open position, the pair of fingers 62 and 66 are spaced-apart from one another in a wider distance. In the open position, the jaws move away from one another. The pair of fingers remains parallel as the pair of jaws displace between the open and closed position, and in the open and closed positions.

The pair of jaws 54 and 58, and the arms 70 and 74 thereof, can include an intervening platform 98 disposed between the pair of fingers 62 and 66, and oriented perpendicular thereto. The pair of fingers and the pair of jaws form a block C-shape configured to engage three contiguous lateral sides of the smart phone camera without obstructing longitudinal front or back of the smart phone camera. The platform 98 can be bifurcated or split, with one portion carried by the stationary jaw 54 and arm 70, and the other portion carried by the movable jaw 58 and arm 74. The intervening platform 98 can receive the smart phone camera thereon. Thus, the opposing fingers 62 and 66 can engage and pinch opposite ends or sides of the smart phone camera, while the intervening platform 98 can engage or receive an intervening side or end of the smart phone camera. The clamp can engage three contiguous sides of the smart phone camera.

The pair of fingers 62 and 66, and the intervening platform 98, having a concave channel formed therein to cup at least a portion of a perimeter edge of the smart phone camera. Thus, the clamp can hold and cradle a perimeter of the smart phone camera, without interfering with the front or back surfaces, or camera or display thereof. The inside surface of the fingers, platform, or channels thereof, can have a padding disposed thereon to protect the smart phone camera, and/or improve a frictional grip on the smart phone camera.

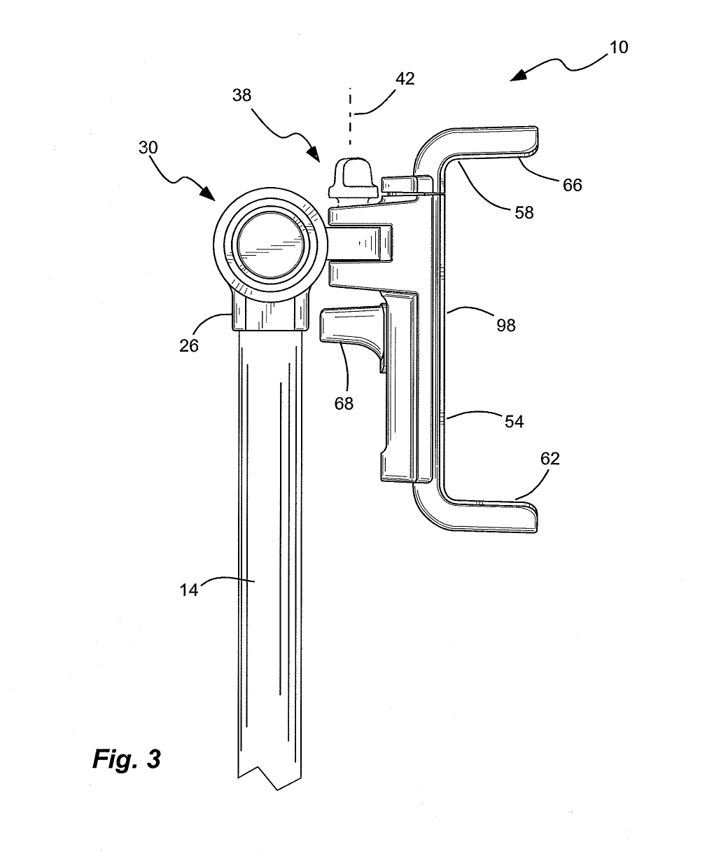

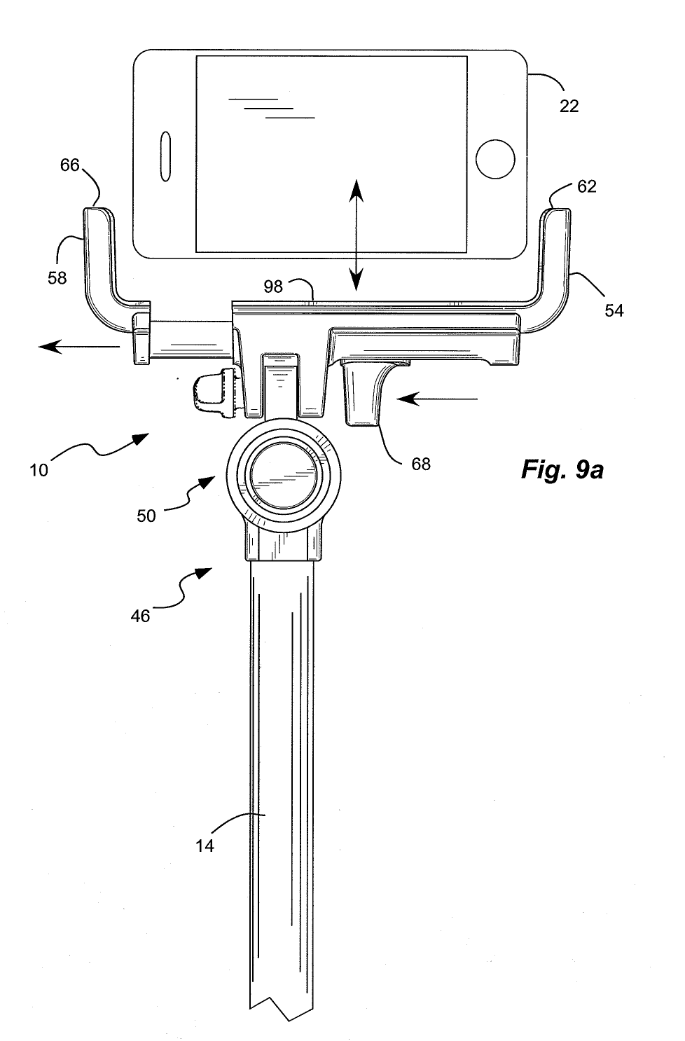

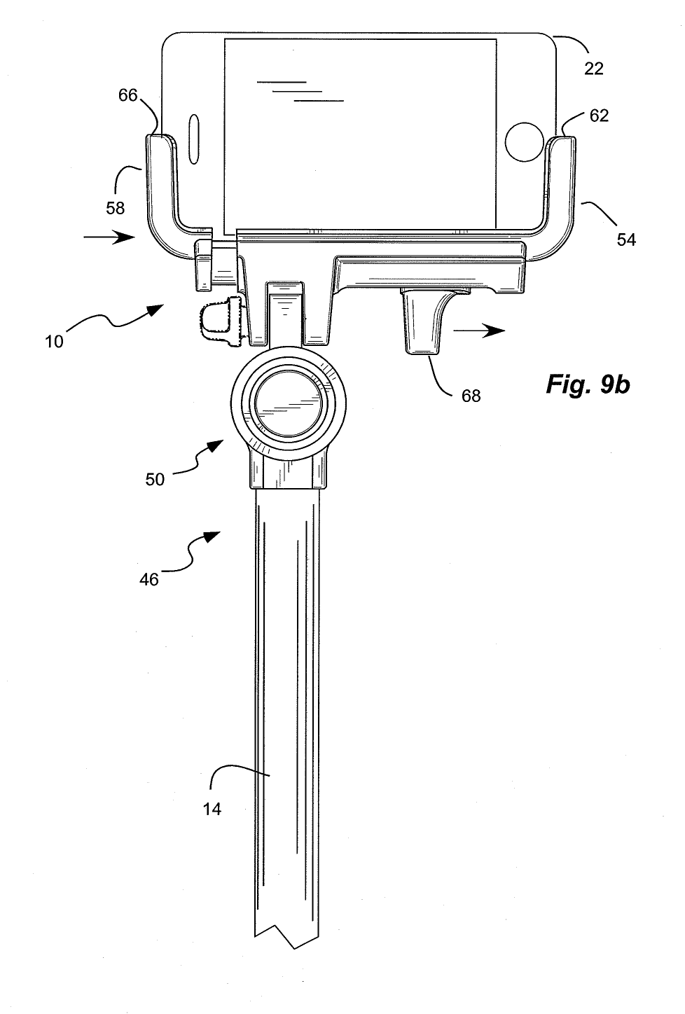

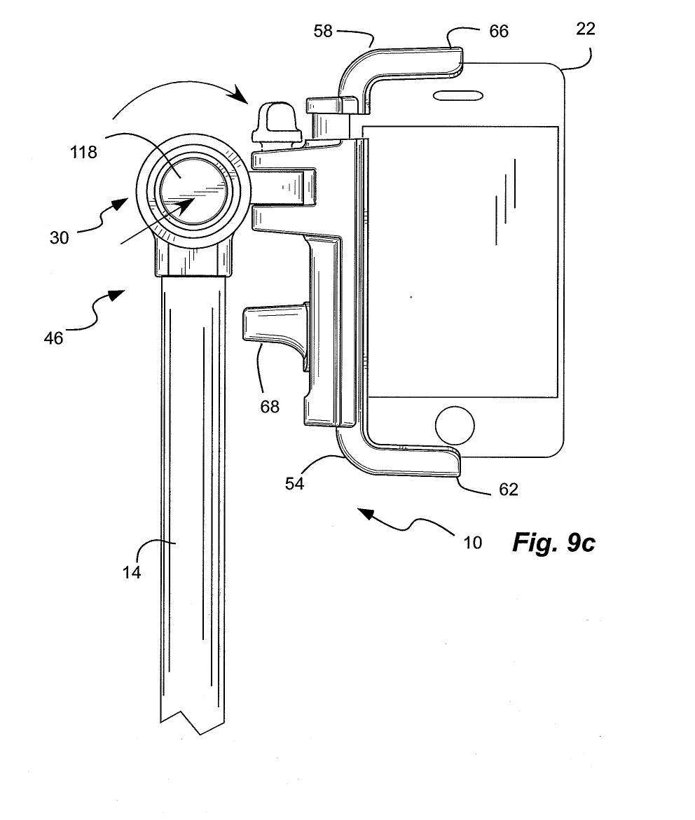

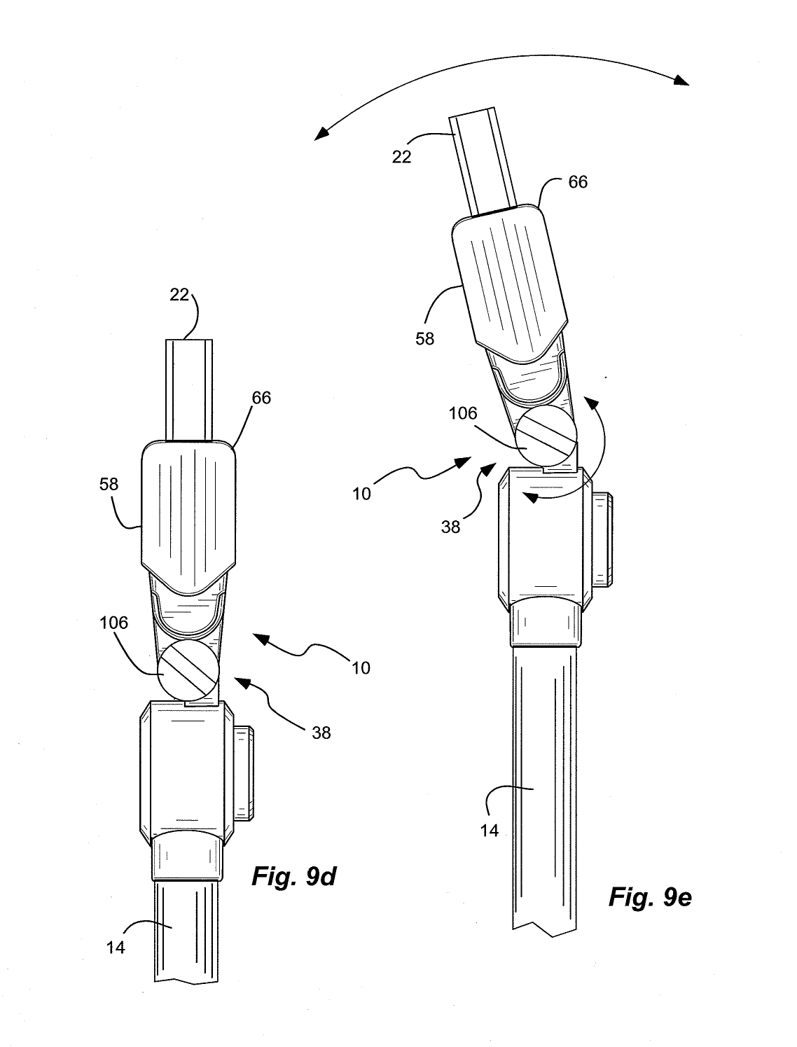

As described above, the coupling 26 and the joint(s) 30 and/or 38 form or define a base 50. The base 50, and joint(s), can be coupled between the pair of jaws 54 and 58 and the monopod 14. The pair of jaws 54 and 58 can be pivotal about the longitudinal pivot axis 34 between: a landscape orientation (FIGS. 1a-2b, 9b), and a portrait orientation (FIGS. 3, 9c). In the landscape orientation, the pair of fingers 62 and 66 can be vertically oriented. The pair of jaws 54 and 58, and the fingers 62 and 66 and the intervening platform 98, can receive the smart phone camera in a landscape orientation (width wider than height), as shown in FIG. 9b. The smart phone camera can rest upon the intervening platform 98, and be pinched between the fingers 62 and 66, and the jaws 54 and 58. Thus, the jaws and the fingers close upon the smart phone camera. In another aspect, a tablet computer can be received within the jaws while in the landscape orientation, while the tablet computer is in a portrait orientation. In the portrait orientation, the pair of fingers 62 and 66 can be horizontally oriented. The pair of jaws 54 and 58, and the fingers 62 and 66, can receive the smart phone camera in a portrait orientation (width narrower than height), or the jaws with the smart phone camera therein can be pivoted about the longitudinal pivot axis 34, as shown in FIG. 9c. The smart phone camera can rest upon one of the fingers 62 and jaws 54, and be pinched between the fingers 62 and 66, and the jaws 54 and 58. Again, the jaws and the fingers close upon the smart phone camera. The spring 90 presses the fingers and jaws together to hold the smart phone camera.

The pair of joints (longitudinal and lateral) 30 and 38 can have pivot axes 34 and 42, respectively, that are oriented perpendicular to one another. The longitudinal axis 34 can extend longitudinally, or fore and aft (towards the direction of picture or video capture), while the lateral axis 42 can extend laterally, or side-to-side. Thus, the clamp 10 can have two degrees of rotational freedom. The clamp can also be turned about the monopod 14 or coupling 26 (or the vertical axis). Thus, the clamp 10 can have three degrees of rotational freedom. With respect to the lateral joint 38, the jaws 54 and 58 can be pivotally coupled to a tab 102 extending from the longitudinal joint 30 and into a gap 104 of the stationary jaw 54 by a screw 106, such as a threaded thumb or wing screw, extending through a bore in the stationary jaw and tab. The screw 106 can be manually turned to loosen the attachment of the jaws to the tab 102, so that the jaws and the smart phone camera can pivot up and down about the lateral axis 42, as shown in FIG. 9e. The screw 106 can be tightened at the desired angle. The gap 104 in the stationary jaws can be formed between a pair of protrusions extending from the stationary jaw. Thus, a portion, such as the pair of protrusions, can form a portion of the base.

With respect to the longitudinal joint 30, the jaws 54 and 58, and the lateral joint 38, can be pivotally coupled to the coupling 26. The longitudinal joint 30 can include a pair hubs rotatably coupled to one another, and lockable with respect to one another. An outer hub 110 can be attached to and carried by the coupling 26. An inner hub 114 can be rotatably disposed in the outer hub 110. The tab 102 can be attached to the inner hub 114, and can extend out of an arcuate slot in the outer hub 110. A spring loaded button 118 can be disposed in the in inner hub 114, and can be displaceable along the longitudinal axis 34 between locked and released positions. A spring member can bias the button in the locked position. In addition, the button 118 can include one or more teeth that engage both the outer and inner hubs 110 and 144 in the locked position. Pushing the button 118 moves the teeth out of engagement, and allows the inner hub to rotate with respect to the outer hub. The button can lock at both the landscape and portrait orientations. Referring to FIGS. 9a-e, a method for holding a smart phone camera 22 and using the trigger actuated clamp 10 described above is shown. A base 50 of a clamp 10, or a monopod 14 attached thereto, or both, is gripped by a hand of a user. The base 50 includes a stationary jaw 54. The clamp 10 includes the base 50 (and stationary jaw 54) and a slider 58 (or movable jaw) slidably coupled thereto. The base 50 (and stationary jaw 54) and the slider 58 can each have a finger 62 and 66 extending therefrom in a spaced-apart relationship. The base 50 and the slider 58, and thus the fingers 62 and 66, can be biased together, such as by the spring 90. A trigger 68 is pulled by a finger of the user. The trigger 68 is attached to the slider 58 to displace the slider 58 and the finger 66 attached thereto away from the base 50 and the finger 62 attached thereto to separate the fingers and open the clamp, as shown in FIG. 9a. The smart phone camera 22 is inserted between the fingers 62 and 66, and onto an intervening platform 98. The trigger 68 is released by the user's finger to allow the slider 58 and the finger 66 attached thereto to displace towards the base 50 and the finger 62 attached thereto to hold the smart phone camera between the fingers and to close the clamp, as shown in FIG. 9b. The smart phone camera 22 is now held in a stable manner and can take pictures and/or video. In addition, the user does not have arm fatigue by holding the smart phone camera for prolonged period. The height of the monopod 14 can be adjusted by telescoping the legs as known in the art.

Referring to FIG. 9c, a button 118 on the base 50 (or longitudinal pivot joint 30) can be pushed to unlock an upper portion of the base (such as the inner hub 114, tab 102, jaws 54 and 58, etc.) with the smart phone camera pivotally coupled to a lower portion of the base (such as the outer hub 110, coupling 26) with the monopod. Pushing the button disengages the teeth from the hubs. The upper portion of the base with the smart phone camera is pivoted with respect to the lower portion of the base with the monopod. The jaws and the smart phone camera can be pivoted back and forth between landscape and portrait orientations as desired by the user and/or to suit the situation or smart phone camera.

Referring to FIGS. 9d and 9e, the screw 106 can be loosened and tightened, and the jaws 54 and 58, and thus the smart phone camera, pivoted up and down as desired by the user and/or to suit the situation or smart phone camera.

Referring again to FIG. 9a, the smart phone camera can be grasped by the user, and the trigger pulled by the user, to displace the slider 58 and the finger 66 attached thereto away from the base 50 and the finger 62 attached thereto to separate the fingers and open the clamp. The smart phone camera can then be removed from between the fingers.

The clamp 10 and the monopod 14 can also have a storage position for transport and storage, such as in a user's pocket. In the storage position, the clamp 10 is pivoted to towards the monopod 14, as shown in FIG. 3. In addition, in the storage position, the monopod can be collapsed. Thus, prior to use, the button 118 on the base 50 (or longitudinal joint 30) can be pushed to unlock an upper portion of the base pivotally coupled to a lower portion of the base with the monopod. The upper portion of the base can be pivoted from the storage position towards the monopod, to a use position or landscape position away from the monopod.

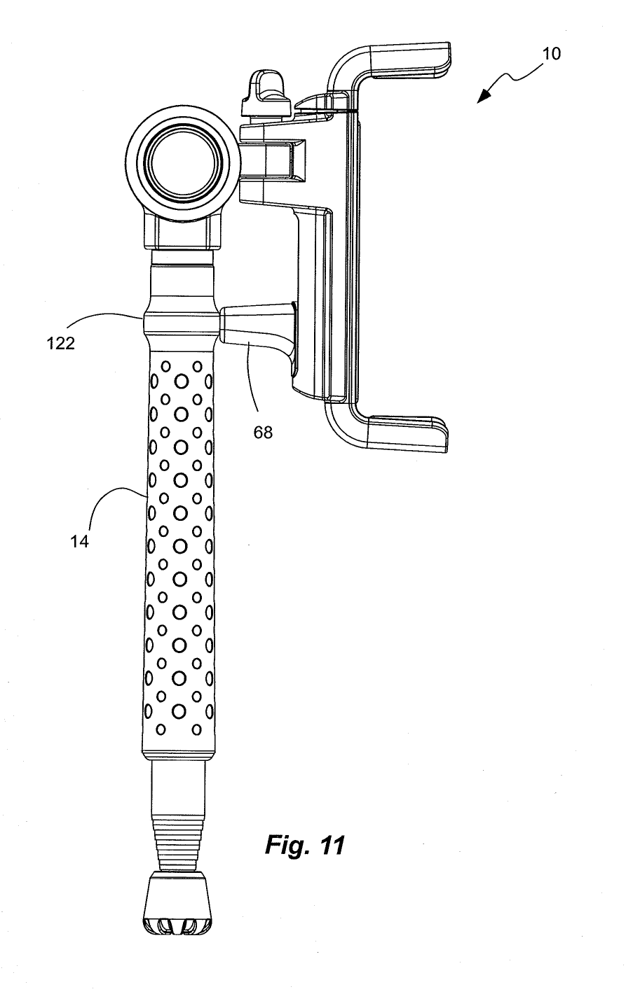

Referring to FIG. 11, the monopod 14 can have a collar 122, or other protrusion extending outward from the grip, and abutting the to trigger 68. The trigger can abut to the collar 122, the protrusion extending from the grip, the grip or the monopod to resist overturning the clamp with respect to the monopod and breaking the longitudinal joint 30.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A trigger actuated clamp device configured to hold a smart phone camera, comprising:
a) a pair of telescoping jaws including a stationary jaw and a movable jaw slidable with respect to the stationary jaw;
b) a pair of opposing fingers oriented parallel and spaced-apart from one another and carried by the pair of jaws;
c) a base attached to the stationary jaw and forming at least a portion of a vertically oriented grip;
d) a trigger attached to the movable jaw and extending therefrom to oppose the grip and spaced-apart from the grip, the trigger being pullable towards the grip to displace the pair of jaws, and thus the pair of opposing fingers, away from one another; and
e) bias means for biasing the pair of jaws, and thus the pair of fingers, towards one another, and for biasing the trigger away from the grip.

2. A device in accordance with claim 1, wherein the pair of fingers has at least two positions, including:
a) a closed position in which the pair of fingers are spaced-apart from one another in a narrower distance; and
b) an open position in which the pair of fingers are spaced-apart from one another in a wider distance.

3. A device in accordance with claim 1, wherein the pair of fingers remain parallel as the pair of jaws displace.

4. A device in accordance with claim 1, further comprising:
a) the stationary jaw having a proximal opening and a distal slot;
b) the movable jaw having an arm extending through the proximal opening and into the stationary jaw; and
c) the trigger being attached to the arm of the movable jaw and extending therefrom out of the slot.

5. A device in accordance with claim 1, further comprising:
a) a proximal opening in the stationary jaw having a U-shaped cross-section with a tongue extending into the opening;
b) an arm of the movable jaw having a U-shaped cross-section extending through the proximal opening in the stationary jaw;
c) the trigger being disposed on a proximal end of the arm; and
d) the bias means including a spring disposed between the tongue of the stationary jaw and the trigger.

6. A device in accordance with claim 1, further comprising:
an intervening platform disposed between the pair of fingers and oriented perpendicular thereto.

7. A device in accordance with claim 6, further comprising:
the pair of fingers and the intervening platform having a concave channel formed therein configured to cup at least a portion of a perimeter edge of the smart phone camera.

8. A device in accordance with claim 6, further comprising:
the platform being bifurcated with one portion carried by the stationary jaw and the other portion carried by the movable jaw.

9. A device in accordance with claim 1, wherein the pair of fingers and the pair of jaws form a block C-shape configured to engage three contiguous lateral sides of the smart phone camera without obstructing a longitudinal front or back of the smart phone camera.

10. A device in accordance with claim 1, wherein the pair of jaws includes a pair of L-shaped members with vertical fingers and telescoping horizontal arms, with a proximal end of the arm of the stationary jaw attached to the base, and a proximal end of the arm of the movable jaw attached to the trigger.

11. A device in accordance with claim 1, wherein the base further comprises:
a) a coupling configured to be coupled to a monopod;
b) a joint with a horizontally oriented, longitudinal pivot axis attached to the coupling; and
c) the pair of jaws being pivotal about the longitudinal pivot axis between:
i) a landscape orientation in which the pair of fingers are vertically oriented; and
ii) a portrait orientation in which the pair of fingers are horizontally oriented.

12. A device in accordance with claim 1, wherein the base further comprises:
a) a coupling configured to be coupled to a monopod; and
b) a pair of joints coupled between the coupling and the pair of jaws, and each having a pivot axis oriented perpendicular to one another.

13. A device in accordance with claim 1, in combination with:
a) a monopod coupled to the pair of jaws; and
b) a smart phone camera releasably held by the pair of jaws.

14. A device in accordance with claim 13, further comprising:
the pair of fingers and an intervening platform having a concave channel formed therein cupping a perimeter edge of the smart phone camera around at least a majority of the perimeter edge while exposing substantially all of a rear of the smart phone camera.

15. A trigger actuated clamp device in combination with a monopod and a smart phone camera, the device comprising:
a) a coupling coupled to the monopod;
b) a joint with a longitudinal pivot axis attached to the coupling;
c) the monopod, or the coupling and the joint, or both forming a substantially vertically oriented grip;
d) a pair of telescoping jaws coupled to the joint and including a stationary jaw and a movable jaw slidable with respect to the stationary jaw;
e) the stationary jaw having a proximal opening and a distal slot;
f) the movable jaw having an arm extending through the proximal opening and into the stationary jaw;
g) the pair of jaws having a pair of opposing fingers oriented parallel and spaced-apart from one another, and movable towards and away from one another, and an intervening platform disposed between the pair of fingers and oriented perpendicular thereto;
h) a spring biasing the pair of fingers towards one another;
i) a trigger attached to the arm of the movable jaw and extending therefrom out of the slot of the stationary jaw to oppose the grip and spaced-apart therefrom, the trigger biased away from the grip by the spring, the trigger being pullable towards the grip to displace the pair of jaws, and thus the pair of opposing fingers, away from one another; and
j) the pair of fingers and the intervening platform having a concave channel formed therein;
k) the pair of fingers and the intervening platform cupping a perimeter edge of the smart phone camera around at least a majority of the perimeter edge while exposing substantially all of a rear of the smart phone camera;
l) the pair of fingers having at least two positions, including:
i) a closed position in which the pair of fingers are spaced-apart from one another in a narrower distance; and
i) an open position in which the pair of fingers are spaced-apart from one another in a wider distance;
m) the pair of fingers and the pair of jaws forming a block C-shape to engage three contiguous lateral sides of the smart phone camera without obstructing longitudinal front or back of the smart phone camera; and
n) the pair of jaws including a pair of L-shaped members with vertical fingers forming the pair of fingers, and telescoping horizontal arms, with a proximal end of the arm of the stationary jaw attached to the joint, and a proximal end of the arm of the movable jaw attached to the trigger.

16. A method for holding a smart phone camera, comprising:
a) gripping a base of a clamp, or a monopod attached thereto, or both, the clamp including the base and a slider slidably coupled thereto and each having a finger extending therefrom in a spaced-apart relationship, and the base and slider, and thus the fingers, being biased together;
b) pulling a trigger attached to the slider to displace the slider and the finger attached thereto away from the base and the finger attached thereto to separate the fingers and open the clamp;
c) inserting the smart phone camera between the fingers; and
d) releasing the trigger to allow the slider and the finger attached thereto to displace towards the base and the finger attached thereto to hold the smart phone camera between the fingers and to close the clamp.

17. A method in accordance with claim 16, further comprising:
a) pushing a button on the base to unlock an upper portion of the base with the smart phone camera pivotally coupled to a lower portion of the base with the monopod; and
b) pivoting the upper portion of the base with the smart phone camera with respect to the lower portion of the base with the monopod.

18. A method in accordance with claim 16, further comprising:
a) grasping the smart phone camera;
b) pulling the trigger to displace the slider and the finger attached thereto away from the base and the finger attached thereto to separate the fingers and open the clamp; and
c) removing the smart phone camera from between the fingers.

19. A method in accordance with claim 18, further comprising:
a) pushing a button on the base to unlock an upper portion of the base pivotally coupled to a lower portion of the base with the monopod; and
b) pivoting the upper portion of the base from a position away from the monopod to a storage position towards the monopod.

20. A method in accordance with claim 16, further comprising:
a) pushing a button on the base to unlock an upper portion of the base pivotally coupled to a lower portion of the base with the monopod; and
b) pivoting the upper portion of the base from a storage position towards the monopod to a use position away from the monopod prior to inserting the smart phone camera.
